(19) United States
(12) Patent Application Publication
(10) Pub. No.: US 2026/0113635 A1
(43) Pub. Date: Apr. 23, 2026

(54) INTEGRITY MANAGEMENT OF AI/ML BASED POSITIONING

(71) Applicant: Telefonaktiebolaget LM Ericsson (PUBL), Stockholm (SE)

(72) Inventors: Yufei BLANKENSHIP, Kildeer, IL (US); Zhan ZHANG, Beijing (CN)

(21) Appl. No.: 19/117,713

(22) PCT Filed: Sep. 27, 2023
(86) PCT No.: PCT/EP2023/076651

§ 371 Date: Apr. 2, 2025

(30) Foreign Application Priority Data
Oct. 3, 2022 (WO) PCT/CN2022/123690

(51) Int. Cl. H04W 12/104; H04L 41/16; H04W 56/00; H04W 64/00

(52) U.S. Cl. CPC H04W 12/104; H04L 41/16; H04W 56/0015; H04W 64/00

(57) ABSTRACT

The embodiments herein relate to integrity management of Artificial Intelligence/Machine Learning, AI/ML, based positioning. In some embodiments, there proposes a method (300) performed by a first network element (202) implementing Positioning Integrity Management Function, PIMF. In an embodiment, the method (300) may comprise the step of identifying (S301) one or more error sources. In an embodiment, the method (300) may further comprise the step of transmitting (S302) a message related to integrity for an AI/ML based positioning based on the one or more error sources to a second network element (101, 102). The message may comprise at least one of a first information element, IE, indicating an integrity alert of the AI/ML based positioning or a second IE indicating a real-time status of the AI/ML based positioning. With the embodiments herein, the PIMF may identify one or more error sources and send integrity alert to other network element for reducing the risk for positioning integrity.

### CROSS REFERENCE TO RELATED APPLICATION

This application claims priority of PCT Application Serial Number PCT/CN2022/123690 filed on Oct. 3, 2022 with title of “INTEGRITY MANAGEMENT OF AI/ML BASED POSITIONING”, the entire contents of which are incorporated herein by reference.

### TECHNICAL FIELD

The embodiments herein relate generally to the field of positioning, and more particularly, the embodiments herein relate to integrity management of Artificial Intelligence/Machine Learning (AI/ML) based positioning.

### BACKGROUND

Learning capability of AI creates advantageous policies or strategies directly based on data instead of human logics and symbolic modeling and analysis. AI/ML enabled solutions essentially employ data-driven learning approaches where the models learn the underlying data distribution and relationship between the inputs and outputs without the need for understanding the underlying complex processes. ML has been found to be an effective tool in radio positioning, for instance, 3gpp has now been investigating on AI/ML based positioning method, i.e., channel state information or time of arrival measurements based so-called fingerprint method for positioning, especially for indoor. More details may be referred to 3GPP TR 38.901 V16.1.0 (2019 December) Technical Report, 3rd Generation Partnership Project: Technical Specification Group Radio Access Network: “Study on channel model for frequencies from 0.5 to 100 GHz (Release 16)”.

In 3GPP Rel-17, for Global Navigation Satellite System (GNSS) based positioning methods, the GNSS integrity concepts were introduced. Integrity for Radio Access Technology (RAT)-dependent positioning methods is currently under development in 3GPP.

### SUMMARY

The embodiments herein propose methods, network elements, computer readable medium and computer program product for integrity management of AI/ML based positioning.

In some embodiments, there proposes a method performed by a first network element implementing Positioning Integrity Management Function (PIMF). In an embodiment, the method may comprise the step of identifying one or more error sources. In an embodiment, the method may further comprise the step of transmitting a message related to an integrity for an AI/ML based positioning, based on the one or more error sources to a second network element. The message may comprise at least one of a first information element (IE) indicating an integrity alert of the AI/ML based positioning and/or a second IE indicating a real-time status of the AI/ML based positioning.

In some embodiments, there proposes a method performed by a second network element. In an embodiment, the method may comprise the step of receiving a message related to an integrity for an AI/ML based positioning from a first network element implementing PIMF. The message may comprise at least one of a first IE indicating an integrity alert of the AI/ML based positioning or a second IE indicating a real-time status of the AI/ML based positioning.

In an embodiment, the first IE may be an AIML-Integrity-ServiceAlert, which may indicate whether the corresponding AI/ML assisted method and the assistance data for AI/ML can be used for integrity related applications.

In an embodiment, the AIML-Integrity-ServiceAlert may further comprise an AIML-DoNotUse flag to indicate the corresponding AI/ML assisted method cannot be used.

In an embodiment, the AIML-Integrity-ServiceAlert may further comprise an AIML-AssistanceData-DoNotUse flag to indicate the corresponding assistance data for AI/ML cannot be used.

In an embodiment, the second IE may be an AIMLPos-RealTimeIntegrity.

In an embodiment, the AIMLPos-RealTimeIntegrity may further comprise an AIML-BadModelList to indicate a list of one or more bad AI/ML models.

In an embodiment, the one or more bad AI/ML models may comprise one or more error sources from AI/ML model performance comprising at least one of: outdated AI/ML model, AI/ML model under routine maintenance, and AI/ML model being moved to an environment that the model is not trained for.

In an embodiment, the AIMLPos-RealTimeIntegrity may further comprise an AIML-BadSignalList to indicate a list of one or more bad signals.

In an embodiment, the one or more bad signals may comprise at least one of one or more error sources in measurement and one or more error sources in assistance data.

In an embodiment, the one or more error sources in measurement may further comprise at least one of: Received Signal Time Difference (RSTD), Receiving Time of Arrival (RTOA), UE Rx-Tx time difference, gNB Rx-Tx time difference, Angle-of-Arrival (AoA), Angle of Departure (AoD), signal spatial beam IDs, Reference Signal Received Power (RSRP), Reference Signal Received signal Path Power (RSRPP), Reference Signal Receiving Quality (RSRQ), interference levels, and signal strengths.

In an embodiment, the one or more error sources in assistance data may further comprise at least one of: Transmission Reception Point (TRP) location, angle reference point (ARP) location, inter-TRP synchronization, and UE/gNB Rx/Tx timing error.

In an embodiment, the AI/ML based positioning may be an AI/ML assisted positioning, which may comprise AI/ML assisted Downlink Time Difference of Arrival (DL-TDOA), AI/ML assisted Uplink Time Difference of Arrival (UL-TDOA), AI/ML assisted multi-Round Trip Time (multi-RTT), AI/ML assisted Downlink Angle of Departure (DL-AoD), and AI/ML assisted Uplink Angle-of-Arrival (UL-AoA).

In an embodiment, the AI/ML assisted positioning may be AI/ML assisted DL-TDOA, for which both Location Management Function (LMF)-based positioning integrity mode and User Equipment (UE)-based positioning integrity mode are applicable. In an embodiment, the one or more error sources in measurement may comprise RSTD estimate from the AI/ML model, for LMF-based positioning integrity mode. In an embodiment, the one or more error sources in assistance data may comprise at least one of TRP location for UE-based positioning integrity mode, and inter-TRP synchronization for LMF-based positioning integrity mode.

In an embodiment, the AI/ML assisted positioning may be AI/ML assisted UL-TDOA, for which LMF-based positioning integrity mode is applicable. In an embodiment, the one or more error sources in measurement may comprise RTOA estimate from the AI/ML model. In an embodiment, the one or more error sources in assistance data may comprise inter-TRP synchronization.

In an embodiment, the AI/ML assisted positioning may be AI/ML assisted multi-RTT, for which LMF-based positioning integrity mode is applicable. In an embodiment, the one or more error sources in measurement may comprise at least one of UE Rx-Tx time difference estimate from the AI/ML model at UE side, and gNB Rx-Tx time difference estimate from the AI/ML model at gNB side.

In an embodiment, the one or more error sources in assistance data may further comprise UE/gNB Rx/Tx timing error.

In an embodiment, the AI/ML assisted positioning may be AI/ML assisted DL-AoD, for which both LMF-based positioning integrity mode and UE-based positioning integrity mode are applicable. In an embodiment, the one or more error sources in assistance data may comprise TRP location for UE-based positioning integrity mode.

In an embodiment, the AI/ML assisted positioning may be AI/ML assisted UL-AoA, for which LMF-based positioning integrity mode is applicable. In an embodiment, the one or more error sources in measurement may comprise AoA estimate from the AI/ML model. In an embodiment, the one or more error sources in assistance data may comprise ARP location.

In an embodiment, the AI/ML based positioning may be a direct AI/ML positioning, for which both LMF-based positioning integrity mode and UE-based positioning integrity mode are applicable. In an embodiment, the one or more bad signals may comprise one or more error sources comprising at least one of: TRP location, ARP location, inter-TRP synchronization, and UE/gNB Rx/Tx timing error.

In an embodiment, the first network element implementing PIMF may be a network element located within a third network element implementing a Location Management Function (LMF) or located within a g-NB.

In an embodiment, the second network element may be a User Equipment (UE) or a g-NB.

In an embodiment, the methods may be implemented in an indoor environment.

In some embodiments, there proposes a network element, comprising: at least one processor; and a non-transitory computer readable medium coupled to the at least one processor. In an embodiment, the non-transitory computer readable medium may store instructions executable by the at least one processor, whereby the at least one processor may be configured to perform the above methods related to the above network elements. In an embodiment, the network element may be configured as the above first network element and/or the second network element.

In some embodiments, there proposes a computer readable medium stores computer readable code, which when run on an apparatus, causes the apparatus to perform any of the above methods.

In some embodiments, there proposes a computer program product stores computer readable code, which when run on an apparatus, causes the apparatus to perform any of the above methods.

With the embodiments herein, the PIMF may identify one or more error sources and send integrity alert to other network element for reducing the risk for positioning integrity.

### BRIEF DESCRIPTION OF THE DRAWINGS

The accompanying drawings, which are incorporated herein and form part of the specification, illustrate various embodiments of the present disclosure and, together with the description, further serve to explain the principles of the disclosure and to enable a person skilled in the pertinent art to make and use the embodiments disclosed herein. In the drawings, like reference numbers indicate identical or functionally similar elements, and in which:

FIG. 1 shows an example scenario of radio propagation;

FIG. 2 is a schematic block diagram showing example architecture of a wireless communication system for integrity management of AI/ML based positioning, in which the embodiment herein may be implemented:

FIG. 3 is a schematic flow chart showing an example method in the first network element, according to the embodiments herein:

FIG. 4 is a schematic flow chart showing an example method in the second network element, according to the embodiments herein:

FIG. 5 is a schematic block diagram showing an example first network element, according to the embodiments herein:

FIG. 6 is a schematic block diagram showing an example second network element, according to the embodiments herein; and

FIG. 7 is a schematic block diagram showing an example computer-implemented apparatus, according to the embodiments herein.

### DETAILED DESCRIPTION OF EMBODIMENTS

Embodiments herein will be described in detail hereinafter with reference to the accompanying drawings, in which embodiments are shown. These embodiments herein may, however, be embodied in many different forms and should not be construed as being limited to the embodiments set forth herein. The elements of the drawings are not necessarily to scale relative to each other.

Reference to “one embodiment” or “an embodiment” means that a particular feature, structure or characteristic described in connection with the embodiment is included in at least one embodiment. Thus, the appearances of the phrase “in an embodiment” appearing in various places throughout the specification are not necessarily all referring to the same embodiment.

### Indoor Factory Positioning

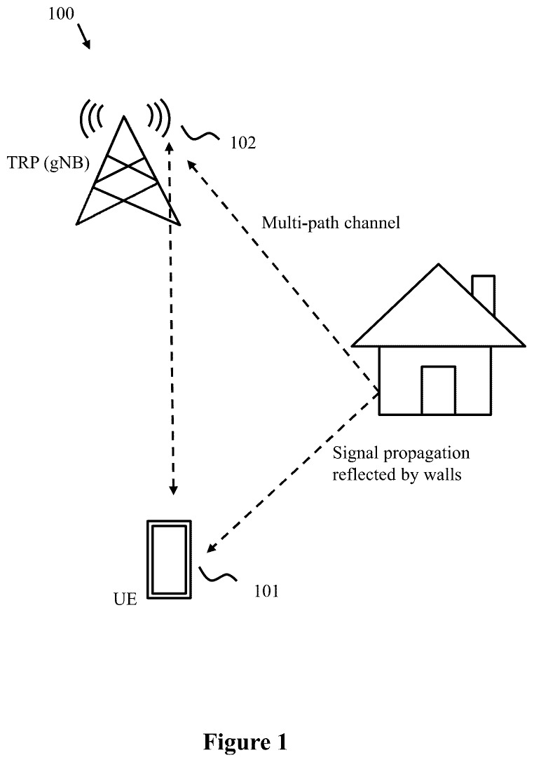

3gpp study item on fingerprint-based machine learning method for indoor position has been under progress. FIG. 1 shows an example scenario 100 of radio propagation.

As illustrated in FIG. 1, different radio propagations between the UE 101 and the gNB 102 could result in quite different channel features, such as channel coherent bandwidth, channel variation over time and space. One of the most import feature is that the channel become rich multipath at indoor, especially when the indoor is fully occupied with a lot of so-called clutters, such as machines and storages. The line of sight (LOS) between the radio base station antenna (TRP) and the User-terminal (UE) 101 is seldom available.

### Integrity Alert

Positioning integrity is measure of the trust in the accuracy of the position-related data provided by the positioning system and the ability to provide timely and valid warnings to the LCS client when the positioning system does not fulfil the condition for intended operation. Integrity focused on the tail of the positioning error distribution (i.e., the rare events), and to aims to keep the probability of hazardous events extremely low. For example, <10⁻⁷/hr Target Integrity Risk (TIR) translates to one failure permitted every 10 million hours (equivalent to 1142 years approximately).

Positioning accuracy and positioning integrity are related but separate concepts, and for many use cases, accuracy alone is insufficient to meet the requirements. Positioning devices and services are typically designed to report the distribution of errors that characterize the overall system performance, which is often specified as an error percentile representing the accuracy. For example, a road vehicle with an embedded UE positioning client may report a lane-level accuracy of <50 cm 95th percentile. In this case, the UE is indicating that, based on all the computed positions, its estimated accuracy is better than 50 cm, 95% of the time. For the remaining 5%, the position error is unknown. The 5% of errors are essentially unbounded without any way to reliably validate their distribution.

Each time a position is provided, positioning integrity can be used to quantify the trust on the provided position. Positioning integrity is therefore a method of bounding these errors and this can be done to a much higher confidence. For example, a Target Integrity Risk (TIR) of 10⁻⁷/hr translates to a 99.99999% probability that no hazardously misleading outputs occurred in a given hour of operation. The TIR sets the target for determining which feared events need to be monitored in order to meet the specified Alert Limit (AL) at this level of probability. A lower TIR introduces a wider range of threats (i.e., feared events) that need to be monitored to improve confidence in the estimated position. Erroneous position estimates which do not meet the positioning integrity criteria can then be omitted in the final positioning solution, allowing only the valid position estimates to be utilized, which also leads to higher accuracy.

Therefore, positioning integrity is an important component to ensure the reliability of a positioning system to the end user. It is an important metric in use cases such as V2X, real-time operation in assembly line, tracking of vehicles in logistics and warehousing, etc.

In general, several key concepts for Integrity support are listed below.

Target Integrity Risk (TIR): The probability that the positioning error exceeds the Alert Limit (AL) without warning the user within the required Time-to-Alert (TTA).

Alert Limit (AL): The maximum allowable positioning error such that the positioning system is available for the intended application. If the positioning error is beyond the AL, the positioning system should be declared unavailable for the intended application to prevent loss of positioning integrity.

Time-to-Alert (TTA): The maximum allowable elapsed time from when the positioning error exceeds the Alert Limit (AL) until the function providing positioning integrity annunciates a corresponding alert.

Integrity Availability: The integrity availability is the percentage of time that the PL is below the required AL.

Protection Level (PL): A statistical upper-bound of the Positioning Error (PE) that ensures that, the probability per unit of time of the true error being greater than the AL and the PL being less than or equal to the AL, for longer than the TTA, is less than the required TIR, i.e., the PL satisfies the following inequality:

Probability per unit of time [((PE>AL) & (PL<=AL)) for longer than TTA]<required TIR

Recent discussion at 3gpp indicated some potential accuracy gain at some indoor cases by AI/ML based method, and some existing simulation even indicated a great advance in accuracy, however, on the other hand, there are a precondition for this method, that is the measurement data of radio signal features (time delay or RSRP, channel impulse responses, etc.) with an accurate label of its positioning, these features might be time varying due to many factors such as indoor radio environment changes by indoor equipment location changes. In addition, the service area might be of different positioning accuracy. Therefore, this gives a rise of issue on managing the positioning integrity of the AI/ML solutions.

In view of the above issues, the embodiments propose a solution for integrity management of AI/ML based positioning.

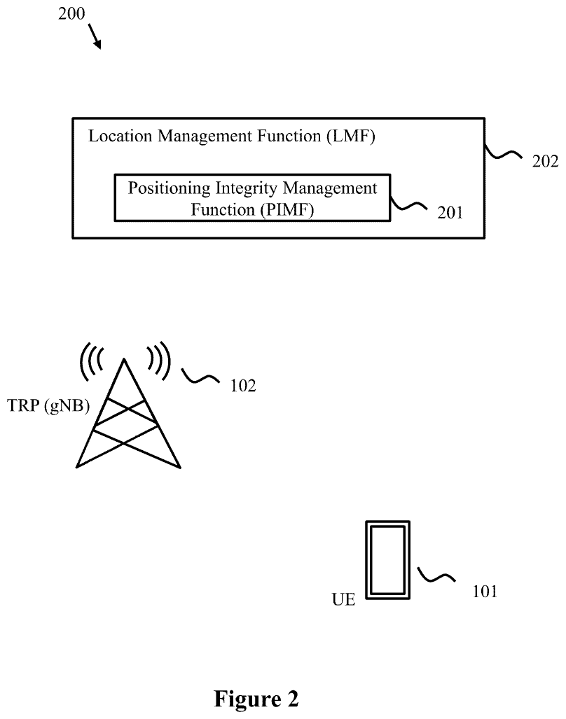

FIG. 2 is a schematic block diagram showing example architecture of a wireless communication system 200 for integrity management of AI/ML based positioning. In an embodiment, the embodiments may be implemented in the wireless communication system 200 as shown in FIG. 2.

In some embodiments, a Hazardous Misleading Information (HMI) may be flagged to positioning service client if feared events are monitored. This may offer a great added value to the positioning service besides the positioning estimates themselves. Therefore, this demands positioning system (here in this disclosure, RAN or Radio network as a positioning service provider) to be equipped with a management on the integrity of the service and behind that a methodology to monitor positioning accuracy as compared to AL (Alert Limit) and PL (Protection Level), and/or to detect positioning malfunction events.

In some embodiments, for the AI/ML positioning method, a positioning integrity management function 201 is established and operates to secure integrity requirement to be met.

In an embodiment, the wireless communication system 200 may be configured in an OTT scenario. The OTT connection may be transparent in the sense that the participating communication devices through which the OTT connection passes are unaware of routing of uplink and downlink communications. For example, a base station (such as the gNB 102) may not or need not be informed about the past routing of an incoming downlink communication with data originating from the PIMF 201, or the LMF 202 to be forwarded (e.g., handed over) to a connected UE 101. Similarly, the base station (such as the gNB 102) need not be aware of the future routing of an outgoing uplink communication originating from the UE 101 towards the PIMF 201, or the LMF 202.

It should also be understood that, a network function (such as Positioning Integrity Management Function (PIMF) 201 and/or Location Management Function (LMF) 202) can be implemented either as a network element on a dedicated hardware, as a software instance running on a dedicated hardware, or as a virtualized function instantiated on an appropriate platform, e.g., on a cloud infrastructure.

It should also be understood that, a network element may be any of the entity and/or function on the network, for example UE 101, base station (such as gNB 102, gNB-CU, gNB-DU), and any network function (such as PIMF 201 and/or LMF 202).

A location server is a more generic term. In 3GPP NR, the LMF 202 is a typical location server. Thus, the LMF 202 and location server are used interchangeably below.

In an embodiment, the PIMF 201 may be a function of the LMF 202 or other network element.

In the following, metrics, signaling, and procedures related to PIMF 201 of AI/ML based positioning will be described.

In general, the following aspects are to be investigated:
(1) Error sources for the AI/ML based positioning methods,
(2) Error source models for each error source,
(3) Integrity alerts or DNU (do-not-use) flag which is used to indicate whether a positioning component can be used to obtain positioning estimate.

This disclosure focuses on aspects (1) and (3): Error sources and Integrity alerts or DNU (do-not-use) flag.

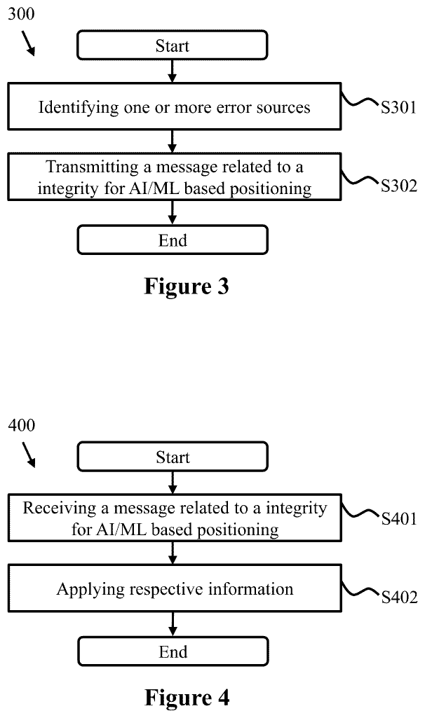

FIG. 3 is a schematic flow chart showing an example method 300 in the first network element, according to the embodiments herein. In an embodiment, the flow chart in FIG. 3 may be implemented in the PIMF 201.

In an embodiment, the method 300 may be implemented in an indoor environment.

The method 300 may begin with step S301, in which the PIMF 201 may identify one or more error sources.

For AI/ML based positioning methods, the error sources may comprise:
(a) Errors in assistance data (e.g., TRP location, Inter-TRP synchronization errors (e.g., Round-Trip-Delay (RTD))),
(b) Errors in measurements (e.g., ToA, Rx-Tx timing difference),
(c) Errors from AI/ML model performance.

The error sources may be studied differently for different variant of AI/ML based positioning method.
One aspect to consider is AI/ML approach. That is, for AI/ML assisted positioning and direct AI/ML positioning, positioning integrity may be supported.
Another aspect to consider is where the AI/ML model is deployed. That is, UE-side AI/ML model, or network-side model, or two-sided model may be supported.

### Error Sources in AI/ML Assisted Positioning

For AI/ML assisted positioning, the AI/ML may provide improved input to the existing positioning methods like DL-TDOA, UL-TDOA, multi-RTT, DL-AOD, UL-AoA. The improved input provided by AI/ML model may depend on the corresponding positioning method. For example, for timing-based positioning methods (DL-TDOA, UL-TDOA, multi-RTT), the AI/ML model may generate LOS/NLOS indicator and/or timing estimates (e.g., ToA, RSTD, RxTxTimeDiff), which are then used as input to the legacy positioning methods.

Thus, for each legacy positioning methods, the error sources of AI/ML assisted methods may be similar to the corresponding legacy method.
AI/ML assisted DL-TDOA. Both LMF-based and UE-based positioning integrity mode may be applicable, depending on which node (LML or UE) calculates the UE location.
Errors in measurements: For LMF-based positioning integrity mode, the error source may comprise the RSTD estimate provided by AI/ML model.
Errors in assistance data:
For UE-based positioning integrity mode, the error sources may comprise TRP location, the same as non-AI/ML-assisted DL-TDOA:
For UE-based positioning integrity mode, the error sources may comprise inter-TRP synchronization, if the AI/ML model is not trained to handle inter-TRP synchronization error, or the actual inter-TRP synchronization error is larger than that the maximum synchronization error the AI/ML model is trained for. Otherwise, inter-TRP synchronization error is not an error source.
AI/ML assisted UL-TDOA. The LMF-based positioning integrity mode may be applicable.
Errors in measurements: The error source may comprise the RTOA estimate provided by AI/ML model.
Errors in assistance data: The error sources may comprise inter-TRP synchronization, if the AI/ML model is not trained to handle inter-TRP synchronization error, or the actual inter-TRP synchronization error is larger than that the maximum synchronization error the AI/ML model is trained for. Otherwise, inter-TRP synchronization error is not an error source.
AI/ML assisted multi-RTT. The LMF-based positioning integrity mode may be applicable.
Errors in measurements: The error sources may comprise: UE Rx-Tx time difference estimate (which may be provided by an AI/ML model at UE side) and gNB Rx-Tx time difference estimate (which may be provided by an AI/ML model at gNB side).
AI/ML assisted DL-AoD. Both LMF-based and UE-based positioning integrity mode may be applicable, depending on which node (LML or UE) calculates the UE location.
Errors in assistance data: For UE-based positioning integrity mode, the error sources may comprise TRP location, the same as non-AI/ML-assisted DL-AoD.
AI/ML assisted UL-AoA. The LMF-based positioning integrity mode may be applicable.
Errors in measurements: The angle-of-arrival (AoA) estimate provided by AI/ML model may be an error source. The error may be expressed as the error of the AoA/ZoA in LCS or GCS or the error of a defined function of AoA/ZoA in LCS.
Errors in assistance data: The error source may comprise the ARP location, the same as non-AI/ML-assisted UL-AoA.

Additionally, for timing-based positioning methods (DL-TDOA, UL-TDOA, multi-RTT), the error source may comprise UE/gNB Rx/Tx timing error.
The error source may comprise UE/gNB Rx/Tx timing error, if the AI/ML model is not trained to handle inter-TRP synchronization error, or the actual UE/gNB Rx/Tx timing error is larger than that the timing error the AI/ML model is trained for.
Otherwise, UE/gNB Rx/Tx timing error is not an error source for the AI/ML assisted positioning method.

### Error Sources in Direct AI/ML Positioning

For direct AI/ML positioning, the AI/ML model may directly generate the estimated target UE position as model output. The AI/ML model may be deployed on the UE-side or network-side, thus corresponding to UE-based positioning integrity mode and LMF-based and UE-based positioning integrity mode, respectively.

The error sources may or may not comprise inter-TRP synchronization.
Inter-TRP synchronization may be an error source if the AI/ML model is not trained to handle inter-TRP synchronization error, or the actual inter-TRP synchronization error is larger than that the maximum synchronization error the AI/ML model is trained for.
Otherwise, inter-TRP synchronization error is not an error source.

The error sources may or may not comprise UE/gNB Rx/Tx timing error.
UE/gNB Rx/Tx timing error may be an error source if the AI/ML model is not trained to handle UE/gNB Rx/Tx timing error, or the actual UE/gNB Rx/Tx timing error is larger than that the maximum timing error the AI/ML model is trained for.
Otherwise, UE/gNB Rx/Tx timing error is not an error source.

The error source may or may not comprise TRP location error or ARP location error.
If the AI/ML model is trained using training dataset that is generated for the same set of TRP (or ARP) as those in model deployment, then TRP/ARP location error is not an error source.
Otherwise (i.e., training dataset is generated for one set of TRP (or ARP), deployment is for a different set of TRP (or ARP), the TRP/ARP location error may be an error source.

### Error Sources Common to AI/ML Based Positioning

Additionally, considering life-cycle-management (LCM) issues, there may be other error sources specific to AI/ML model deployment. Specifically, the error source may comprise the following:
Outdated AI/ML model. If the deployment environment drifts too far from the environment that the AI/ML model is trained for, the AI/ML model cannot generate accurate position estimate of the target UE. For example, even if the UE stays in the same indoor factory floor, movement of the UE itself or objects in its environment may cause the AI/ML model to deteriorate over time. A model monitoring function may monitor the model performance in real time and flag the model as “Do Not Use” (DNU).
AI/ML model is under routine maintenance (e.g., the model is being update or fine-tuned, hardware upgrade, software upgrade), thus temporarily unavailable.
The AI/ML model is being moved to an environment that the model is not trained for (e.g., a model trained for indoor factory is moved to urban macro), thus the model should not be used.

When both AI/ML based and non-AI/ML based methods are available, one of them (AI/ML or non-AI/ML) may be flagged as DNU, so that the alternative method (non-AI/ML or AI/ML) is used instead. The DNU flag may be triggered for the AI/ML based method due to various reasons described above. Furthermore, the UE (UE-based positioning integrity mode) or location server (LMF-based positioning integrity mode) may indicate the model ID which should not be used for positioning.

Then, the method 300 may proceed to step S302, in which the first network element may transmit, to a second network element, a message related to an integrity for an AI/ML based positioning, based on the one or more error sources.

As may be seen above, several error sources exist for AI/ML based positioning. In the following, some information elements are shown to illustrate the integrity related signaling for AI/ML based positioning methods.

### Signaling to Support Integrity of AI/ML Assisted Positioning

The IE AIML-Integrity-ServiceAlert may be used for example by the location server to indicate whether the corresponding AI/ML assisted method and the assistance data for AI/ML can be used for integrity related applications.

| AIML-Integrity-ServiceAlert-r17 ::= SEQUENCE { | |
|---|---|
| AIML-DoNotUse-r17 | BOOLEAN, |
| AIML-AssistanceData-DoNotUse-r17 | BOOLEAN, |

...
}

The IE AIMLPos-RealTimeIntegrity may be used to provide parameters that describe the real-time status of the AI/ML model operation. If an AI/ML model is unhealthy, or some signals used by the AI/ML model is unhealthy, then the bad model ID or bad signals may be indicated.

| AIMLPos-RealTimeIntegrity ::= SEQUENCE { | |
|---|---|
| AIML-BadModelList | AIML-BadModelList, |
| AIML-BadSignalList | AIML-BadSignalList, |

...
}

As explained earlier, the potential bad signals may comprise the error source in measurements and the error source in assistance data:
error source in measurements:
RSTD (received signal time difference),
RTOA (Receiving time of arrival,
UE Rx-Tx time difference, gNB Rx-Tx time difference
angle-of-arrival
angle of departure
signal spatial beam IDs
reference signal received power (RSRP) or reference signal received signal path power (RSRPP)
interference levels (RSRQ)
signal strengths.
error source in assistance data:
TRP location
ARP location
inter-TRP synchronization
UE/gNB Rx/Tx timing error.

In an embodiment, the PIMF 201 may also broadcast system information about service levels of integrity and service categories provided.

The PIMF 201 may be responsible to broadcast system information and service levels in term of positioning availability (integrity) status of for different RAN serving areas (such as cells and sectors) to the network elements. The system information may indicate required measurements, measurement quality, and reporting periodicity (timing), and AI/ML model IDs for positioning service user to choose and communicate. The PIMF 201 may trigger the information such as Misleading Information (MI) or Hazardous Misleading Information (HMI) if integrity issue is found and service integrity targets could not be maintained.

The PIMF 201 may also optionally instruct network elements (especially positioning service users) on the reasons of suspending the service, such as adverse link quality issues due to inferences, for minimizing driving test efforts.

FIG. 4 is a schematic flow chart showing an example method 400 in the second network element, according to the embodiments herein. In an embodiment, the flow chart in FIG. 4 may be implemented in the UE 101 or gNB 102.

In an embodiment, the method 400 may be implemented in an indoor environment.

The method 400 may begin with step S401, in which the second network element may receive a message related to integrity for an AI/ML based positioning from a first network element implementing PIMF. The message may comprise at least one of a first IE indicating an integrity alert of the AI/ML based positioning or a second IE indicating a real-time status of the AI/ML based positioning.

Then, the method 400 may proceed to step S402, in which the second network element may apply the information as received in the step S401 for integrity application.

In an embodiment, the configurations for a message related to integrity for an AI/ML based positioning for the method 300 may also be applicable for the method 400. More details are omitted herein.

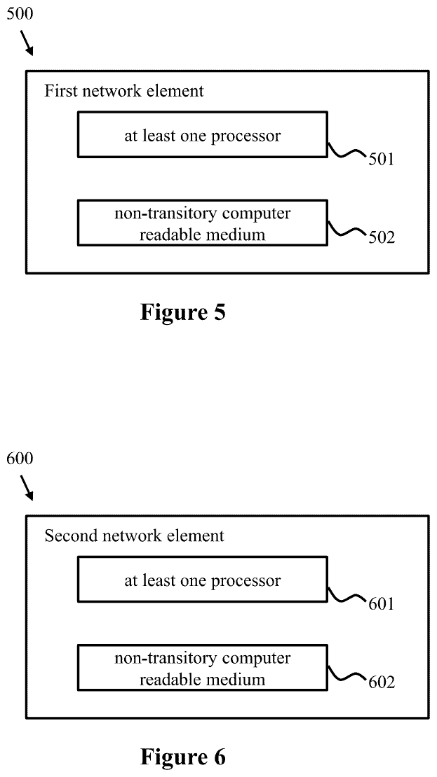

FIG. 5 is a schematic block diagram showing an example first network element 500, according to the embodiments herein. In an embodiment, the example first network element 500 in FIG. 5 may be implemented as the PMIF 201 in FIG. 2.

In an embodiment, the first network element 500 may comprise at least one processor 501; and a non-transitory computer readable medium 502 coupled to the at least one processor 501. The non-transitory computer readable medium 502 may store instructions executable by the at least one processor 501, whereby the at least one processor 501 is configured to perform the steps in the example methods 300 as shown in the schematic flow charts of FIG. 3; the details thereof are omitted here.

Note that, the first network element 500 may be implemented as hardware, software, firmware and any combination thereof. For example, the first network element 500 may comprise a plurality of units, circuities, modules or the like, each of which may be used to perform one or more steps of the example method 300.

FIG. 6 is a schematic block diagram showing an example second network element 600, according to the embodiments herein. In an embodiment, the example second network element 600 in FIG. 6 may be implemented as the gNB 102 and/or UE 101 in FIGS. 1 and 2.

In an embodiment, the second network element 600 may comprise at least one processor 601; and a non-transitory computer readable medium 602 coupled to the at least one processor 601. The non-transitory computer readable medium 602 may store instructions executable by the at least one processor 601, whereby the at least one processor 601 is configured to perform the steps in the example method 400 as shown in the schematic flow charts of FIG. 4: the details thereof are omitted here.

Note that, the second network element 600 may be implemented as hardware, software, firmware and any combination thereof. For example, the second network element 600 may comprise a plurality of units, circuities, modules or the like, each of which may be used to perform one or more steps of the example method 400.

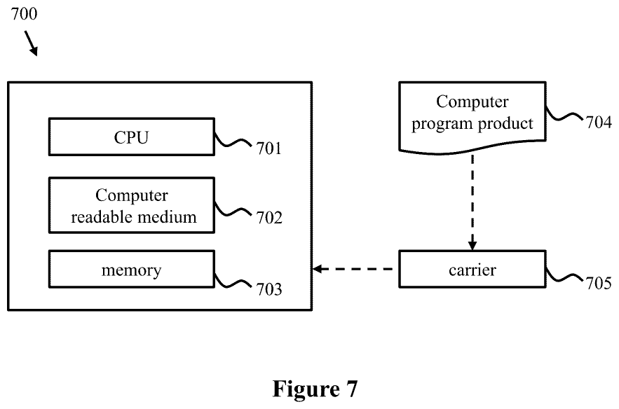

FIG. 7 is a schematic block diagram showing an example computer-implemented apparatus 700, according to the embodiments herein. In an embodiment, the apparatus 700 may be configured as the above mentioned apparatus, such as the UE 101, the gNB 102, or the PMIF 201.

In an embodiment, the apparatus 700 may comprise but not limited to at least one processor such as Central Processing Unit (CPU) 701, a computer-readable medium 702, and a memory 703. The memory 703 may comprise a volatile (e.g., Random Access Memory, RAM) and/or non-volatile memory (e.g., a hard disk or flash memory). In an embodiment, the computer-readable medium 702 may be configured to store a computer program and/or instructions, which, when executed by the processor 701, causes the processor 701 to carry out any of the above mentioned methods.

In an embodiment, the computer-readable medium 702 (such as non-transitory computer readable medium) may be stored in the memory 703. In another embodiment, the computer program may be stored in a remote location for example computer program product 704 (also may be embodied as computer-readable medium), and accessible by the processor 701 via for example carrier 705.

The computer-readable medium 702 and/or the computer program product 704 may be distributed and/or stored on a removable computer-readable medium, e.g. diskette, CD (Compact Disk), DVD (Digital Video Disk), flash or similar removable memory media (e.g. compact flash, SD (secure digital), memory stick, mini SD card, MMC multimedia card, smart media), HD-DVD (High Definition DVD), or Blu-ray DVD, USB (Universal Serial Bus) based removable memory media, magnetic tape media, optical storage media, magneto-optical media, bubble memory, or distributed as a propagated signal via a network (e.g. Ethernet, ATM, ISDN, PSTN, X.25, Internet, Local Area Network (LAN), or similar networks capable of transporting data packets to the infrastructure node).

Example embodiments are described herein with reference to block diagrams and/or flowchart illustrations of computer-implemented methods, apparatus (systems and/or devices) and/or non-transitory computer program products. It is understood that a block of the block diagrams and/or flowchart illustrations, and combinations of blocks in the block diagrams and/or flowchart illustrations, may be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that may direct a computer or other programmable data processing apparatus to function in a particular manner, such that the instructions stored in the computer-readable medium produce an article of manufacture comprising instructions which implement the functions/acts specified in the block diagrams and/or flowchart block or blocks. Accordingly, embodiments of present inventive concepts may be embodied in hardware and/or in software (comprising firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams comprise arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the appended examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the following examples of embodiments and their equivalents, and shall not be restricted or limited by the foregoing detailed description.

### Abbreviations

AI Artificial Intelligence
BS Base Station
CE Channel Estimate
MAC Medium Access Control
ML Machine Learning
PBCH Physical Broadcast Channel
PSS Primary Synchronization Signal
RRC Radio Resource Control
RF Radio Frequency
SSS Secondary Synchronization Signal
TRX Transceiver
UE User Equipment.

1.-31. (canceled)

32. A method performed by a first network element implementing Positioning Integrity Management Function, PIMF, comprising:
identifying one or more error sources:
transmitting, to a second network element, a message related to an integrity for an Artificial Intelligence/Machine Learning, AI/ML, based positioning, based on the one or more error sources, wherein the message comprises at least one of a first information element, IE, indicating an integrity alert of the AI/ML based positioning or a second IE indicating a real-time status of the AI/ML based positioning.

33. The method according to claim 32, wherein the first IE is an AIML-Integrity-ServiceAlert, wherein the AIML-Integrity-ServiceAlert indicates whether the corresponding AI/ML assisted method and the assistance data for AI/ML can be used for integrity related applications, further wherein the AIML-Integrity-ServiceAlert further comprises an AIML-DoNotUse flag to indicate the corresponding AI/ML assisted method cannot be used.

34. The method according to claim 33, wherein the AIML-Integrity-ServiceAlert further comprises an AIML-AssistanceData-DoNotUse flag to indicate the corresponding assistance data for AI/ML cannot be used.

35. The method according to claim 32, wherein the second IE is an AIMLPos-RealTimeIntegrity, further wherein the AIMLPos-RealTimeIntegrity further comprises an AIML-BadModelList to indicate a list of one or more bad AI/ML models.

36. The method according to claim 35, wherein the one or more bad AI/ML models comprise one or more error sources from AI/ML model performance comprising at least one of:
outdated AI/ML model,
AI/ML model under routine maintenance,
AI/ML model being moved to an environment that the model is not trained for.

37. The method according to claim 35, wherein the AIMLPos-RealTimeIntegrity further comprises an AIML-BadSignalList to indicate a list of one or more bad signals.

38. The method according to claim 36, wherein the one or more bad signals comprises at least one of one or more error sources in measurement and one or more error sources in assistance data.

39. The method according to claim 38, wherein the one or more error sources in measurement comprises at least one of:
Received Signal Time Difference, RSTD,
Receiving Time of Arrival, RTOA,
UE Rx-Tx time difference,
gNB Rx-Tx time difference,
Angle-of-Arrival, AoA,
Angle of Departure, AoD,
signal spatial beam IDs,
Reference Signal Received Power, RSRP,
Reference Signal Received signal Path Power, RSRPP,
Reference Signal Receiving Quality, RSRQ,
interference levels,
signal strengths.

40. The method according to claim 38, wherein the one or more error sources in assistance data comprises at least one of:
Transmission Reception Point, TRP, location,
angle reference point, ARP, location,
inter-TRP synchronization,
UE/gNB Rx/Tx timing error.

41. The method according to claim 38, wherein the AI/ML based positioning is an AI/ML assisted positioning comprising AI/ML assisted Downlink Time Difference of Arrival, DL-TDOA: AI/ML assisted Uplink Time Difference of Arrival, UL-TDOA: AI/ML assisted multi-Round Trip Time, multi-RTT: AI/ML assisted Downlink Angle of Departure, DL-AoD; and AI/ML assisted Uplink Angle-of-Arrival, UL-AoA.

42. The method according to claim 41, wherein the AI/ML assisted positioning is AI/ML assisted DL-TDOA, for which both Location Management Function, LMF, based positioning integrity mode and User Equipment, UE, based positioning integrity mode are applicable:
wherein the one or more error sources in measurement comprises RSTD estimate from the AI/ML model, for LMF based positioning integrity mode:
wherein the one or more error sources in assistance data comprises at least one of TRP location for UE based positioning integrity mode, and inter-TRP synchronization for LMF based positioning integrity mode.

43. The method according to claim 41, wherein the AI/ML assisted positioning is AI/ML assisted UL-TDOA, for which LMF-based positioning integrity mode is applicable:
wherein the one or more error sources in measurement comprises RTOA estimate from the AI/ML model:
wherein the one or more error sources in assistance data comprises inter-TRP synchronization.

44. The method according to claim 41, wherein the AI/ML assisted positioning is AI/ML assisted multi-RTT, for which LMF-based positioning integrity mode is applicable:
wherein the one or more error sources in measurement comprises at least one of UE Rx-Tx time difference estimate from the AI/ML model at UE side, and gNB Rx-Tx time difference estimate from the AI/ML model at gNB side.

45. The method according to claim 42, wherein the one or more error sources in assistance data further comprises UE/gNB Rx/Tx timing error.

46. The method according to claim 42, wherein the AI/ML assisted positioning is AI/ML assisted DL-AoD, for which both LMF-based positioning integrity mode and UE-based positioning integrity mode are applicable;
wherein the one or more error sources in assistance data comprises TRP location for UE-based positioning integrity mode.

47. The method according to claim 42, wherein the AI/ML assisted positioning is AI/ML assisted UL-AoA, for which LMF-based positioning integrity mode is applicable:
wherein the one or more error sources in measurement comprises AoA estimate from the AI/ML model:
wherein the one or more error sources in assistance data comprises ARP location.

48. The method according to claim 38, wherein the AI/ML based positioning is a direct AI/ML positioning, for which both LMF-based positioning integrity mode and UE-based positioning integrity mode are applicable:
wherein the one or more bad signals comprises one or more error sources comprising at least one of:
TRP location,
ARP location,
inter-TRP synchronization,
UE/gNB Rx/Tx timing error.

49. The method according to claim 32, wherein the first network element implementing PIMF is a network element located within a third network element implementing a Location Management Function, LMF, or located within a g-NB further wherein the second network element is a User Equipment, UE, or a g-NB further wherein the method is implemented in an indoor environment.

50. A method performed by a second network element, comprising:
receiving, from a first network element implementing Positioning Integrity Management Function, PIMF, a message related to an integrity for an Artificial Intelligence/Machine Learning, AI/ML, based positioning, wherein the message comprises at least one of a first information element, IE, indicating an integrity alert of the AI/ML based positioning or a second IE indicating a real-time status of the AI/ML based positioning.

51. The method according to claim 50, wherein the first network element implementing PIMF is a network element located within a third network element implementing a Location Management Function, LMF, or located within a g-NB, further wherein the second network element is a User Equipment, UE, or a g-NB, further wherein the method is implemented in an indoor environment.
